(19) United States
(12) Patent Application Publication
(10) Pub. No.: US 2004/0243932 A1
(43) Pub. Date: Dec. 2, 2004

(54) Providing html-pages that define user interface elements by binding meta-data

(76) Inventors: Lothar Bender, Rauenberg (DE); Xu Xiang, Bad Schonborn (DE); Ulrike Hellbrueck, Sandhausen (DE)

Correspondence Address: FINNEGAN, HENDERSON, FARABOW, GARRETT & DUNNER, LLP, 1300 I STREET, NW, WASHINGTON, DC, 20005, US

(21) Appl. No.: 10/484,243

(22) PCT Filed: Jul. 10, 2002
(86) PCT No.: PCT/EP02/07677

Related U.S. Application Data
(62) Division of application No. 60/306,707, filed on Jul. 20, 2001.

(51) Int. Cl. G06F 15/00; G06F 17/00

(52) U.S. Cl. 715/513

(57) ABSTRACT

A server computer provides an HTML-page for displaying data to a user of a client computer by identifying meta-data with definitions, creating a data object by using meta-data, creating a control entity, providing a first reference from the control entity to the data object, providing a second reference from the data object to the meta-data to enable the control entity to access the meta-data via the references, extracting the definitions from the meta-data into the control entity, and creating the HTML-page by the control entity.

### FIELD OF THE INVENTION

The present invention generally relates to client/server computer systems, and, more particularly, relates to a computer system in that the client has a browser for communicating with the server computer.

### BACKGROUND OF THE INVENTION

In internet computer systems, client computer and server computer communicate via predefined network protocols, such as HTTP und TCP/IP. Generally, a user operates the client computer and inputs data; client computer and network forward the data to the server computer; and the server computer processes the data by an application. Usually, for processing, the server computer uses further computers, such as database computers.

More in detail, a large number of client computers communicates with a single server computer; each client computer is equipped with a browser. Modern programmers refrain from adapting the software on the client computer to the application on the server computer. On the client side, standard browsers are commercially available (e.g., Microsoft Explorer, Netscape Navigator). For each particular application, the server computer instructs the browser by a page in a markup language (i.e. coding). For example, a HTML-page causes the browser to display an input mask that prompts the user to input the data.

In other words, it is desired to leave the browser unchanged with its original standard form, but to put all intelligence to the server computer application.

Business applications and user exchange data: (i) the user reads data on a computer screen, and (ii) the user who writes new data into the application. Usually, the application resides on a server computer and the user operates a client computer.

Examples for applications are R/3, CRM (Customer Relationship Management), available from SAP Aktiengesellschaft, Walldorf (Baden), Germany.

As with all data presentation, meta-data has to be considered as well. However, application developers face the following technical problem: The “non-intelligent” browser does-not know what kind of data arrives from the server; visualizing data only is not sufficient, the server has to integrate all meta-data into the page.

### SUMMARY OF THE INVENTION

In a computer system of the present invention, a server computer has an application to provide HTML-pages; a client computer has a browser to display the pages to a user. To provide the pages, the application uses a dictionary with meta-data, data object and control entity. The application identifies the meta-data with definitions, creates the data object by using the meta-data, creates the control entity, provides a first reference from the control entity to the data object, provides a second reference from the data object to the meta-data so that the control entity accesses the meta-data via the references. Finally, the application extracts the definitions from the meta-data into the control entity and creates the HTML-page.

The present invention provides an HTML page by the following method steps: identifying meta-data with definitions; creating a data object by using meta-data; creating a control entity; providing a first reference from the control entity to the data object; providing a second reference from the data object to the meta-data, thereby enabling the control entity to access the meta-data via the first and second references; extracting the definitions from the meta-data into the control entity; and creating the HTML-page by the control entity.

The present invention also relates to a computer program product for providing an HTML-page, the program with instructions that cause a processor of a computer to execute the method steps.

### BRIEF DESCRIPTION OF THE DRAWINGS

FIG. 1 illustrates a simplified block diagram of the computer network system having a plurality of computers;

FIG. 2 illustrates screen elements for several examples;

FIG. 3 illustrates screen elements for an explanatory example;

FIG. 4 illustrates a server computer in the system of FIG. 1 with components;

FIG. 5 illustrates a simplified structure of the application according to the present invention; and

FIG. 6 illustrates a simplified flow chart diagram of the present invention.

### DETAILED DESCRIPTION OF THE INVENTION

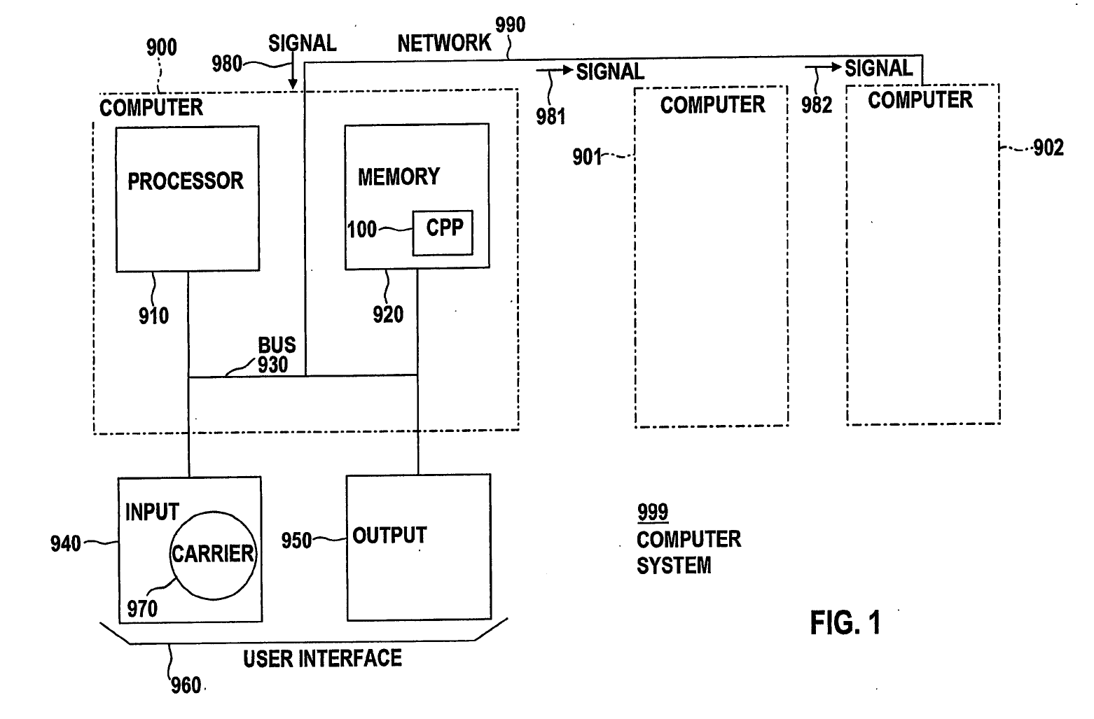

FIG. 1 illustrates a simplified block diagram of the computer network system 999 having a plurality of computers 900, 901, 902 (or 90q, with q=0 . . . Q−1, Q any number).

Computers 900-902 are coupled via inter-computer network 990. Computer 900 comprises processor 910, memory 920, bus 930, and, optionally, input device 940 and output device 950 (I/O devices, user interface 960). As illustrated, the invention is present by computer program product 100 (CPP), program carrier 970 and program signal 980, collectively “program”.

In respect to computer 900, computer 901/902 is sometimes referred to as “remote computer”, computer 901/902 is, for example, a server, a router, a peer device or other common network node, and typically comprises many or all of the elements described relative to computer 900. Hence, elements 100 and 910-980 in computer 900 collectively illustrate also corresponding elements 10q and 91q-98q (shown for q=0) in computers 90q.

Computer 900 is, for example, a conventional personal computer (PC), a desktop and hand-held device, a multiprocessor computer, a pen computer, a microprocessor-based or programmable consumer electronics, a minicomputer, a mainframe computer, a personal mobile computing device, a mobile phone, a portable or stationary personal computer, a palmtop computer or the like.

Processor 910 is, for example, a central processing unit (CPU), a micro-controller unit (MCU), digital signal processor (DSP), or the like.

Memory 920 symbolizes elements that temporarily or permanently store data and instructions. Although memory 920 is conveniently illustrated as part of computer 900, memory function can also be implemented in network 990, in computers 901/902 and in processor 910 itself (e.g., cache, register), or elsewhere. Memory 920 can be a read only memory (ROM), a random access memory (RAM), or a memory with other access options. Memory 920 is physically implemented by computer-readable media, such as, for example: (a) magnetic-media, like a hard disk, a floppy disk, or other magnetic disk, a tape, a cassette tape; (b) optical media, like optical disk (CD-ROM, digital versatile disk—DVD); (c) semiconductor media, like DRAM, SRAM, EPROM, EEPROM, memory stick, or by any other media, like paper.

Optionally, memory 920 is distributed across different media. Portions of memory 920 can be removable or non-removable. For reading from media and for writing in media, computer 900 uses devices well known in the art such as, for example, disk drives, tape drives.

Memory 920 stores support modules such as, for example, a basic input output system (BIOS), an operating system (OS), a program library, a compiler, an interpreter, and a text-processing tool. Support modules are commercially available and can be installed on computer 900 by those of skill in the art. For simplicity, these modules are not illustrated.

CPP 100 comprises program instructions and —optionally—data that cause processor 910 to execute method steps of the present invention. Method steps are explained with more detail below. In other words, CPP 100 defines the operation of computer 900 and its interaction in network system 999. For example and without the intention to be limiting, CPP 100 can be available as source code in any programming language, and as object code (“binary code”) in a compiled form. Persons of skill in the art can use CPP 100 in connection with any of the above support modules (e.g., compiler, interpreter, operating system).

Although CPP 100 is illustrated as being stored in memory 920, CPP 100 can be located elsewhere. CPP 100 can also be embodied in carrier 970.

Carrier 970 is illustrated outside computer 900. For communicating CPP 100 to computer 900, carrier 970 is conveniently inserted into input device 940. Carrier 970 is implemented as any computer readable medium, such as a medium largely explained above (cf. memory 920). Generally, carrier 970 is an article of manufacture comprising a computer readable medium having computer readable program code means embodied therein for executing the method of the present invention. Further, program signal 980 can also embody computer program 100. Signal 980 travels on network 990 to computer 900.

Having described CPP 100, program carrier 970, and program signal 980 in connection with computer 900 is convenient. Optionally, program carrier 971/972 (not shown) and program signal 981/982 embody computer program product (CPP) 101/102 to be executed by processor 911/912 (not shown) in computers 901/902, respectively.

Input device 940 symbolizes a device that provides data and instructions for processing by computer 900. For example, device 940 is a keyboard, a pointing device (e.g., mouse, trackball, cursor direction keys), microphone, joystick, game pad, scanner.

Although the examples are devices with human interaction, device 940 can also operate without human interaction, such as, a wireless receiver (e.g., with satellite dish or terrestrial antenna), a sensor (e.g., a thermometer), a counter (e.g., goods counter in a factory). Input device 940 can serve to read carrier 970.

Output device 950 symbolizes a device that presents instructions and data that have been processed. For example, a monitor or a display, (cathode ray tube (CRT), flat panel display, liquid crystal display (LCD), speaker, printer, plotter, vibration alert device. Similar as above, output device 950 communicates with the user, but it can also communicate with further computers.

Input device 940 and output device 950 can be combined to a single device; any device 940 and 950 can be provided optional.

Bus 930 and network 990 provide logical and physical connections by conveying instruction and data signals. While connections inside computer 900 are conveniently referred to as “bus 930”, connections between computers 900-902 are referred to as “network 990”. Optionally, network 990 comprises gateways being computers that specialize in data transmission and protocol conversion.

Devices 940 and 950 are coupled to computer 900 by bus 930 (as illustrated) or by network 990 (optional). While the signals inside computer 900 are mostly electrical signals, the signals in network are electrical, magnetic, optical or wireless (radio) signals.

Networking environments (as network 990) are commonplace in offices, enterprise-wide computer networks, intranets and the internet (i.e. world wide web). The physical distance between a remote computer and computer 900 is not important. Network 990 can be a wired or a wireless network. To name a few network implementations, network 990 is, for example, a local area network (LAN), a wide area network (WAN), a public switched telephone network (PSTN); a Integrated Services Digital Network (ISDN), an infrared (IR) link, a radio link, like Universal Mobile Telecommunications System (UMTS), Global System for Mobile Communication (GSM), Code Division Multiple Access (CDMA), or satellite link.

Transmission protocols and data formats are known, for example, as transmission control protocol/internet protocol (TCP/IP), hyper text transfer protocol (HTTP), secure HTTP, wireless application protocol, unique resource locator (URL), a unique resource identifier (URI), hyper text markup language HTML, extensible markup language (XML), extensible hyper text markup language (XHTML), wireless application markup language (WML), etc.

Interfaces coupled between the elements are also well known in the art. For simplicity, interfaces are not illustrated. An interface can be, for example, a serial port interface, a parallel port interface, a game port, a universal serial bus (USB) interface, an internal or external modem, a video adapter, or a sound card.

Computer and program are closely related. As used hereinafter, phrases, such as “the computer provides” and “the program provides”, are convenient abbreviation to express actions by a computer that is controlled by a program.

As used herein, computer 900 is referred to as “server computer”, and computer 901 is referred to as “client computer”. Several definitions are added to assist in understanding the present invention:

An application is a business program on a server computer to process content-data. A dictionary is a repository of meta-data on the server computer, or on a different computer that can be accessed by the server computer. The developer is a person who writes the application; the user is a person who operates the client computer. The first direction is the data flow direction from server computer to the user (data output); the second direction is the opposite direction (data input). HTML stands collectively for any markup language such as HTML, XML, WML, and SGML. A page is a document by that the application in the server computer instructs a browser of the client computer; the page is provided in markup language. For communication over a radio network (i.e. mobile communication) using WML, pages are also referred to as “mobile cards”. A screen element (also: “user interface element”) is an item on the screen of the client computer to display data to the user or to receive data from the user. The term “structure element” collectively stands for meta-data, data object, and control entity.

Data stands collectively for (c) content-data and (m) meta-data. Meta-data (or “auxiliary data”) is data that accompanies content-data to define visual presentation of the content-data. Meta-data is stored in the dictionary and describes properties of business information, by type information, semantic information (e.g. language of text) or otherwise. Content-data stands for any business information, i.e. information that is processed by the application. The meta-data aspect (or “focus”) refers to (a) display of content-data on screen (e.g., length of fields, number of characters), (b) the dependency of content-data and meta-data type, (c) the type of content-data (e.g., format string or integer) and (d) the limitations to content-data that are set by meta-data. Binding content-data stands for the 1-to-1-assignment of screen elements to data objects.

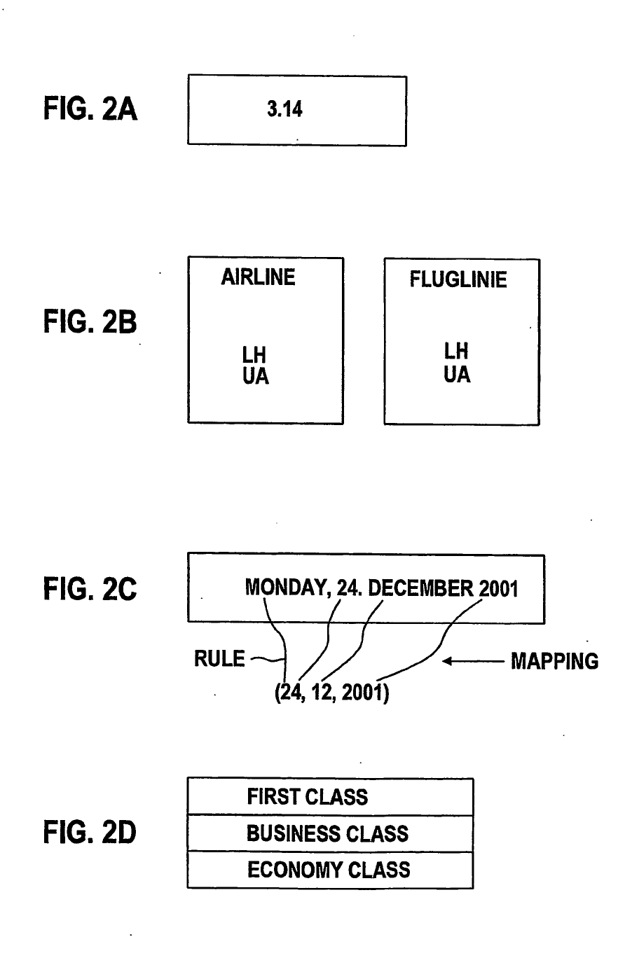

FIG. 2 (A-D) illustrates screen elements for several examples. The screen elements present (c) content-data in combination with (m) meta-data. The screen elements are illustrated as they appear on display 951 of client computer 901. Various meta-data aspects are distinguished.

FIG. 2A illustrates a display aspect by a field with a real number for that the number of digits is limited. The content (c) is a real number with a decimal point, for example, “3,14159 . . . ”; the meta-data (m) is the number of digits right of the decimal point, for example 2 digits. Therefore, displayed is “3.14”.

FIG. 2B illustrates a dependency aspect by tables. Both tables show abbreviations of airlines as (c) content-data. The header of both tables is (m) meta-data. The language of the header depends a language pre-selection. The pre-selection—by itself metadata—is, preferably, stored in server computer 900. Displayed is either the table with the header in English (as on the left) of the table with the header in German (as on the right).

FIG. 2C illustrates the content aspect by presentation of dates. For example, for content-data “24 Dec. 2001”, it is required to store the day, the month and the year. Storing by a set of integers (24, 12, 2001) is sufficient. Depending on meta-data, the date is visualized, for example, as “Monday, 24 Dec. 2001”. Meta-data is the mapping of the second integer from 1 . . . 12 to January to December, respectively; a rule to calculate the day of the week; and the predefined order of presentation (weekday, comma, day, month in words, year in 4 digits).

FIG. 2D illustrates the limiting aspect. To stay with air traffic, meta-data limits a particular airline to provide services in a fixed number of predefined categories, such as “first class”, “business class” and “economy class”. In other words, for that particular airline, other service classes are not allowed.

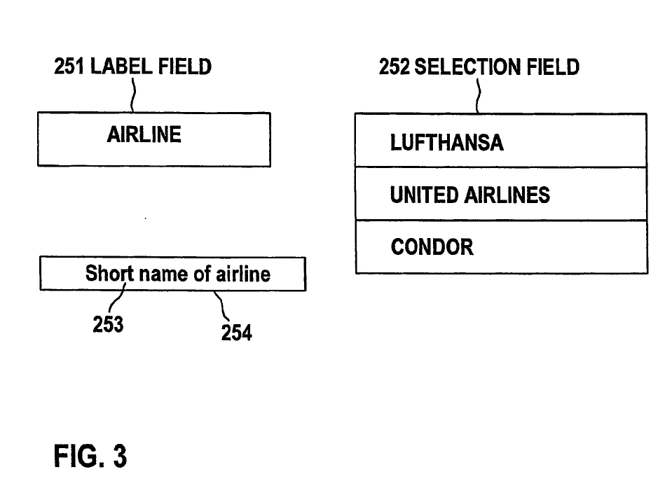

FIG. 3 illustrates screen elements for an explanatory example. The application (on server computer) processes the two-letter codes of airlines, such as “LH” for “Lufthansa”, “DA” for “United Airlines”, etc. The screen elements (by the browser) prompt the user to select the airline. The user is assisted by a so-called “quickinfo” procedure that presents a so-called “tooltip”. In detail, the screen elements are: label field 251 (also: “text field”), showing the text “AIRLINE”; selection field 252 where the user can select an airline, field 252 preferably displayed right of label field 251; explanation text 253 with “short name of the airline”; and box 254 for showing text 253, preferably, located near selection field 252.

The “tooltip” is explanation text 253 displayed in box 254. Preferably, screen elements 251-254 are coded in the page. Box 254 and text 253 are activated when the user moves the mouse over label field 251 or over selection field 252. When selection field 252 is shown to the user, it can already comprise a default value (e.g., “Lufthansa”) or it can be empty.

For explaining the invention by the example of FIG. 3, the following definitions belong to meta-data:

<1> using abbreviations with 2 characters;

<2> the mapping of 2-character-abbreviations to full terms, such as “LH” to “Lufthansa”, “UA” to “United Airlines” and “DE” to “Condor”; and

<3> the text 253 “short name of the airline”.

In comparison, the abbreviations “LH”, “UA” and “DE” belong to content-data. Showing the unabridged names has advantages for the user who is relived from memorizing the abbreviations. Other meta-data, for example, setting the language of text 253 to English, can be implemented by a person of skill in the art accordingly.

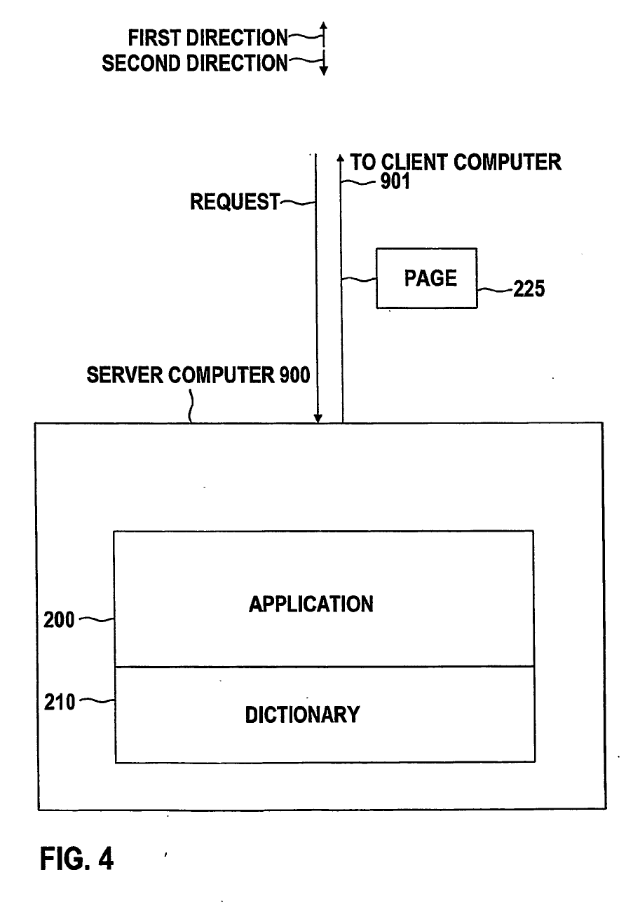

FIG. 4 illustrates server computer 900 with the following components: application 200 that instructs processor 910 (cf. FIG. 1), dictionary 210, and page 225 that application 200 sends to client computer 901 (cf. FIG. 1, first direction). As indicated by an arrow to application 200, a HTML-request (arriving at computer 900) triggers application 200 to execute a method of the present invention that will be described in connection with the following.

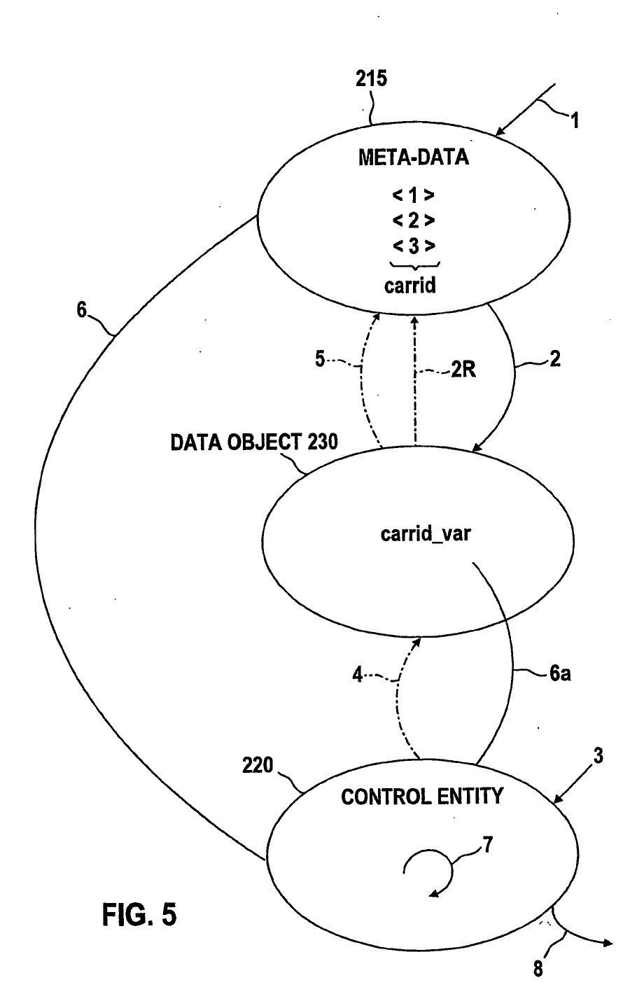

FIG. 5 illustrates a simplified structure of the application according to the present invention. The structure elements are: meta-data 215 (preferably, part of dictionary 210, cf. FIG. 4), data object 230 (preferably, part of application 200), and control entity 220 (preferably, part of application 200).

More in detail, control entity 220 is provided for defining HTML-code in page 225 (cf. FIG. 4) to display screen elements 251-254, and for controlling the execution of application 200. Data object 230 is provided for receiving and storing content-data as well as for handing over content-data to the rest of application 200. Data object 230 is, preferably, programmed in an object-oriented language, such as C++. Object 230 has procedures (so-called “methods”) that cause the execution of method steps. It is an advantage of the present invention that meta and content-data is combined via meta-data 215 and data object 230.

For simplicity of explanation, the following exemplary explanation refers to selection field 252 being a representative example for the other screen elements 251, 253-254 (cf. FIG. 3). As in the following, referencing to and from structure elements is required because any practical application has a plurality of structure elements for other purposes. Persons of skill in the art can accomplish the references by pointers or other identification. References are illustrated by dashed arrows.

The following is a simplified code listing of application 200 (or portions thereof). The programming language here is a self-explanatory pseudo-language, that is:

data: carrid_var type carrid

mySelectionField_var=CreateSelectionField (name=“mySelectionField”)

mySelectionField_var→SetDataObject(carrid_var)

Step (1) Application 200 identifies meta-data 215 (“carrid”, cf. arrow 1 in FIG. 5). Meta-data 215 comprises a type definition of the “carrid” type; the definition comprises meta-data <1>, <2> and <3> as defined above. Meta-data 215 is, for example, stored in a table (“nametab”) in dictionary 210.

Step (2) Application 200 creates (arrow 2) data object 230 under the name “carrid_var”, of the type “carrid”. Creating the object comprises the allocation of memory (e.g., in memory 920) in correspondence with the type definition. As indicated by dashed arrow 2R, data object 230 has a reference to meta-data 215. Preferably, data object 230 assigns a default value to “carrid_var”, such as “LH”.

Step (3) Application 200 creates control entity 220.

Step (4) Application 200 references from control entity 220 to data object 230 (cf. arrow 4).

Step (5) Application 200 references from data object 230 to meta-data 215. Thereby, the reference (arrow 2R) from object 230 to data 215 is used. FIG. 5 illustrates this by showing arrow 5 going parallel to arrow 2R. With both references (arrows 4 and 5) in combination, control entity 220 has access to meta-data 215. In other words, control entity 220 detects—for example according to predefined rules in dictionary 210—that selection field 252 can be accompanied by box 254 and explanation 253.

Step (6) Control entity 220 reads and extracts <1>, <2> and <3> from the type definition of meta-data 215 (arrow 6). Data object 230 is either bypassed or considered. Preferably, data object 230 is considered and the default value of “carrid_var” is transferred to control entity 220 (arrow 6a).

Step (7) Application 200 uses control entity 200 to create HTML-page 225. Control entity 220 considers <1><2> and <3> and—optionally—considers the default value of carrid_var. In other words, control entity 220 writes HTML-code that uses “Lufthansa”, “United Airlines”, “Condor” (instead of the abbreviations) in screen elements 251-254 with explanation 253 “short name of the airline”.

Step (8) Application 200 forwards HTML-page 225 to client computer 901 (arrow 8). Having sent page 225 to the browser, client computer 901 is now able to show the screen elements as in FIG. 3.

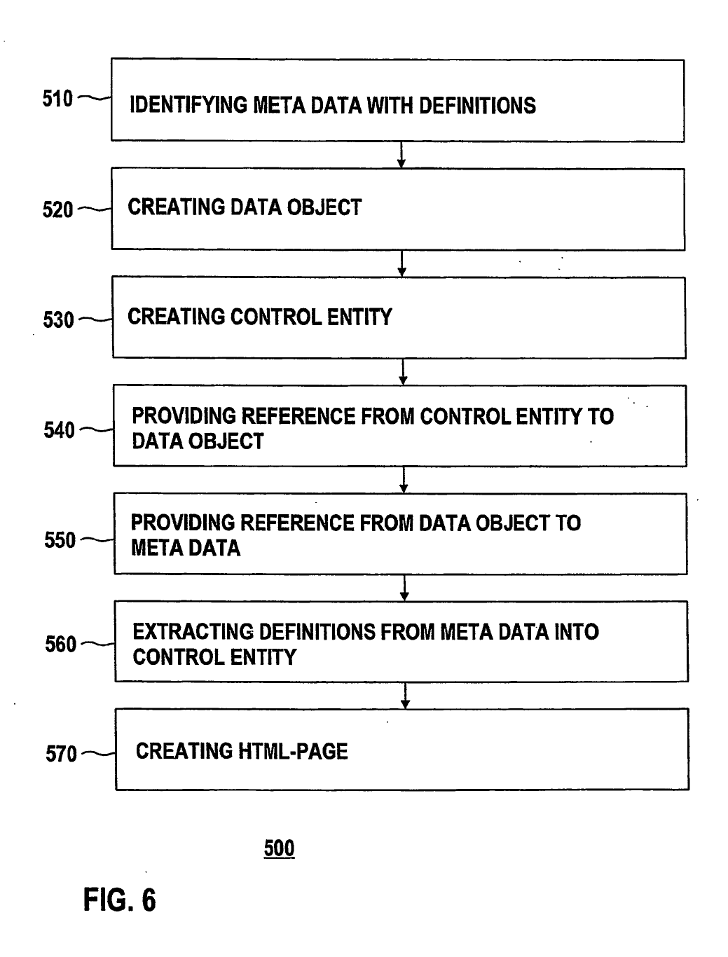

FIG. 6 illustrates a simplified flow chart diagram of method 500 of the present invention. Method 500 for providing HTML-page 225 comprises the following steps: identifying 510 meta-data 215 with definitions (e.g., definitions <1><2><3>); creating 520 data object 230 by using meta-data 215; creating 530 control entity 220; providing 540 a first reference (cf. arrow 4) from control entity 220 to data object 230; providing 550 a second reference (cf. arrow 5) from data object 230 to meta-data 215, thereby enabling control entity 220 to access meta-data 215 via the first and second references; extracting 560 the definitions from meta-data 215 into control entity 220; and creating 570 HTML-page 225 by control entity 220.

Having described the present invention with single dictionary 210 of a single type for storing meta-data 215 is convenient. Optionally, persons of skill in the art can provide further dictionaries of the same type or of a different type. Meta-data 215 remains the same; in other words, only the medium for storing meta-data is modified.

For example, a first dictionary is dictionary 210 (cf. FIG. 4), a second dictionary is an XML-schema. XLM-schemas are well known in the art and described, for example, by the World Wide Web Consortium (http://www.w3.org/XML/Schema).

In case of multiple dictionaries, addressing and referencing is modified. The references to meta-data 215 (e.g. arrows 5, 5R in FIG. 5) are optionally implemented by bi-dimensional references each having a first portion and a second portion.

For example, the portions are separated by symbols “::”; the reference to the first dictionary is: http:// . . . /sysid1/dict3::sflight_carrid and the reference to the second dictionary is: http:// . . . /xmls3/3D4YZ::sflight_carrid. In the example, the second portions “sflight_carrid” are equal. The first and the second portions can be implemented with unique identifiers, such as well-known GUID or Unique Resource Name (URN).

The present invention is summarized as computer program product (CPP) 100 for providing HTML-page 225, with instructions that cause processor 910 of computer 900 to execute the following: identifying 510 meta-data 215 with definitions (e.g., <1><2><3>); creating 520 data object 230 by using meta-data 215; creating 530 control entity 220; providing 540 a first reference (cf. arrow 4) from control entity 220 to data object 230; providing 550 a second reference (cf. arrow. 5) from data object 230 to meta-data 215, thereby enabling control entity 220 to access meta-data 215 via the references; extracting 560 the definitions from meta-data 215 into control entity. 220; and creating 570 HTML-page 225 by control entity 220.

The present invention is now summarized as server computer 900 for providing HTML-page 225, HTML-page 225 for displaying data to the user of client computer 901. Server computer 900 comprises: means to identify 510 meta-data 215 with definitions <1><2><3> (e.g., via dictionary 214, XML-schema); means to create 520 data object 230 by using meta-data 215 (e.g., in memory 920); means to create 530 control entity 220 (e.g., in memory 920); means to provide 540 a first reference from control entity 220 to data object 230 (e.g., pointers, addresses); means to provide 550 a second reference from data object 230 to meta-data 215, thereby enabling control entity 220 to access meta-data 215 via the first 4 and second 5 references (e.g., pointers, addresses); means to extract 560 the definitions from meta-data 215 into control entity 220; and means to create 570 by the control entity the HTML-page (e.g., predefined HTML-coding).

### LIST OF REFERENCES

| Reference | Element |
|---|---|
| 100 | CPP |
| 1-7 | Arrows |
| 200 | Application |
| 210 | Dictionary |
| 215 | Meta-data |
| 220 | Content entity |
| 225 | Page |
| 230 | Data object |
| 251 | Label field |
| 252 | Selection field |
| 253 | Explanation text |
| 254 | Box |
| 5xx | Method with steps |
| 900 | Server computer |
| 910 | Processor |
| 9xx | Computer with components |

1. A method for providing an HTML-page, the method comprising the following steps:
identifying meta-data with definitions;
creating a data object by using meta-data;
creating a control entity;
providing a first reference from the control entity to the data object;
providing a second reference from the data object to the meta-data, thereby enabling the control entity to access the meta-data via the first and second references;
extracting the definitions from the meta-data into the control entity; and
creating by the control entity the HTML-page.

2. A computer program product for providing an HTML-page, the computer program product comprising instructions that cause a processor of a computer to execute the following:
identifying meta-data with definitions:
creating a data object by using meta-data;
creating a control entity;
providing a first reference from the control entity to the data object;
providing a second reference from the data object to the meta-data, thereby enabling the control entity to access the meta-data via the first and second references;
extracting the definitions from the meta-data into the control entity; and
creating by the control entity the HTML-page.

3. A server computer for providing an HTML-page, the HTML-page for displaying data to a user of a client computer, the server computer comprising:
means to identify meta-data with definitions;
means to create a data object by using meta-data;
means to create a control entity;
means to provide a first reference from the control entity to the data object;
means to provide a second reference from the data object to the meta-data, thereby enabling the control entity to access the meta-data via the first and second references;
means to extract the definitions from the meta-data into the control entity; and
means to create by the control entity the HTML-page.

4. A method for providing a markup language page with which an application in a server computer instructs a browser of a client computer, the method comprising the following steps:
identifying meta-data with definitions, the meta-data accompanying content-data to define visual presentation of the content-data;
creating a data object by using meta-data, the data object receiving and storing content-data as well as handing over content-data to the rest of the application;
creating a control entity for controlling the execution of the application:
providing a first reference from the control entity to the data object;
providing a second reference from the data object to the meta-data, thereby enabling the control entity to access the meta-data via the first and second references;
extracting the definitions from the meta-data into the control entity; and
creating the markup language page by the control entity.

5. The method of claim 4, wherein the markup language page is a HTML-page.

6. (Canceled).

7. (Canceled).
